(19) United States
(12) Patent Application Publication
(10) Pub. No.: US 2022/0149673 A1
(43) Pub. Date: May 12, 2022

(54) BOBBIN AND CORE-BOBBIN ASSEMBLY FOR STATOR INCLUDING THE SAME

(71) Applicant: HYUNDAI MOBIS CO., LTD., Seoul (KR)

(72) Inventors: Yeong Woo SEO, Yongin-si (KR); Hye Seong YANG, Yongin-si (KR); Ui Il JEONG, Yongin-si (KR); Yul Kyu SON, Yongin-si (KR)

(73) Assignee: HYUNDAI MOBIS CO., LTD., Seoul (KR)

(21) Appl. No.: 17/524,929

(22) Filed: Nov. 12, 2021

(30) Foreign Application Priority Data
Nov. 12, 2020 (KR) 10-2020-0151323

(51) Int. Cl. H02K 1/14; H02K 3/32; H02K 3/52

(52) U.S. Cl. CPC H02K 1/148; H02K 2203/12; H02K 3/522; H02K 3/325

(57) ABSTRACT

A bobbin includes: a first bobbin member including a first part extending in a direction that crosses a first direction, and a second part extending in a direction that crosses the direction in which the first part extends; a second bobbin member spaced apart from the first bobbin member along the first direction; a third bobbin member spaced apart from the first bobbin member in a second direction that crosses the first direction; and a fourth bobbin member spaced apart from the second bobbin member along the second direction, and spaced apart from the third bobbin member along the first direction. The first, second, third, and fourth bobbin members have shapes and sizes that are compatible.

### CROSS-REFERENCE TO RELATED APPLICATION

This application claims the benefit under 35 U.S.C. § 119(a) of Korean Patent Application No. 10-2020-0151323 filed on Nov. 12, 2020 in the Korean Intellectual Property Office, the entire disclosure of which is incorporated herein by reference for all purposes.

### TECHNICAL FIELD

The present disclosure relates to a bobbin, and a core-bobbin assembly for a stator including the same.

### BACKGROUND

In general, when a coil is wound on a core in a stator of a winding motor, a bobbin coupled to the core is used to prevent damage to the coil due to a burr or a sharp portion of an edge portion and electrically insulate the core and the coil.

However, conventionally, because the size and shape of the core may be variously determined according to the specification of the motor, the bobbin coupled to the core also has to have various sizes and shapes. In this case, because the bobbin has to have various sizes and shapes according to the size and shape of the core, a workability of the motor or the stator deteriorates.

Furthermore, conventionally, because there is no passage, through which a cooling fluid may pass between the core-bobbin assembly and the coil, a cooling performance of the stator including the coil deteriorates.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a bobbin includes: a first bobbin member including a first part extending in a direction that crosses a first direction, and a second part extending in a direction that crosses the direction in which the first part extends; a second bobbin member spaced apart from the first bobbin member along the first direction; a third bobbin member spaced apart from the first bobbin member in a second direction that crosses the first direction; and a fourth bobbin member spaced apart from the second bobbin member along the second direction, and spaced apart from the third bobbin member along the first direction. The first, second, third, and fourth bobbin members have shapes and sizes that are compatible.

The second bobbin member may be mirror-symmetrical to the first bobbin member.

The third bobbin member may be mirror-symmetrical to the first bobbin member.

The fourth bobbin member may be mirror-symmetrical to the second bobbin member and the third bobbin member.

The first bobbin member may include: a third part protruding, in a direction opposite to the first direction, from a distal end of the first part in a third direction that is perpendicular to the first direction and the second direction; and a fourth part protruding, in the direction opposite to the first direction, from a distal end of the first part in a direction that is opposite to the third direction.

The first bobbin member may include a boss having a protruding shape and disposed on a surface of a structure formed by the first part, the third part, and the fourth part being coupled together.

The boss may be disposed in an area in which the first part and the third part meet each other, or an area in which the first part and the fourth part meet each other.

The boss may be disposed on a surface of the first part or the third part.

The first bobbin member may include a groove having a recessed shape and disposed on a surface of a structure formed by coupling the first part, the third part, and the fourth part.

The groove may be disposed on a surface of the first part, the third part, or the fourth part.

The groove may be disposed in an area in which the first part and the third part meet each other, or an area in which the first part and the fourth part meet each other.

A spacing distance between the first bobbin member and the second bobbin member may correspond to a spacing distance between the third bobbin member and the fourth bobbin member. A spacing distance between the first bobbin member and the third bobbin member may correspond to a spacing distance between the second bobbin member and the fourth bobbin member.

The first bobbin member may include: a fifth part protruding, in a direction opposite to the second direction, from a distal end of the second part in a third direction that is perpendicular to the first direction and the second direction; and a sixth part protruding, in the direction opposite to the second direction, from a distal end of the second part in a direction opposite to the third direction.

A length by which the second part extends along a third direction that is perpendicular to the first direction and the second direction may be larger than a length by which the first part extends along the third direction. The first part may be disposed in the length by which the second part extends along the third direction.

In another general aspect, a core-bobbin assembly for a stator includes a core including: a yoke, the yoke having a first surface located on a side of a side surface of the yoke, in a reference direction, and second to fourth surfaces disposed in a clockwise sequence when viewed from a top of the yoke; a first flange coupled to an upper surface of the yoke and protruding in the reference direction and a direction that is opposite to the reference direction; and a second flange coupled to a lower surface of the yoke and protruding in the reference direction and the direction that is opposite to the reference direction. The core-bobbin assembly further includes: a first bobbin member configured to contact a portion of the first surface and a portion of the second surface; a second bobbin member configured to contact another portion of the second surface and a portion of the third surface, and spaced apart from the first bobbin member; a third bobbin member configured to contact another portion of the first surface and a portion of the fourth surface, and spaced apart from the first bobbin member; a fourth bobbin member configured to contact another portion of the third surface and another portion of the fourth surface, and spaced apart from the second bobbin member; and a coil wound on outer surfaces of the first to fourth bobbin members. The first to fourth bobbin members have shapes and sizes that are compatible.

Each of the first to fourth bobbin members may include a boss disposed on a surface thereof, and having a shape that protrudes outward. The core may include a core groove disposed on a surface thereof and having a shape that is recessed inward. The boss included in each of the first to fourth bobbin members may be inserted into the core groove such that the first to fourth bobbin members and the core are coupled to each other.

Each of the first to fourth bobbin members may include a groove having a recessed shape and disposed at a portion of a surface that contacts the core. The core may include a core boss disposed on a surface of the core and having a shape that protrudes outward. The core boss may be inserted into the groove included in each of the first to fourth bobbin members, such that the first to fourth bobbin members and the core are coupled to each other.

The first and second bobbin members may protrude outward from the second surface such that the coil is spaced apart from the second surface by a specific distance. The third and fourth bobbin members may protrude outward from the fourth surface such that the coil is spaced apart from the fourth surface by a specific distance.

Other features and aspects will be apparent from the following detailed description, the drawings, and the claims.

### BRIEF DESCRIPTION OF THE DRAWINGS

The above and other objects, features and advantages of the present disclosure will be more apparent from the following detailed description taken in conjunction with the accompanying drawings:

FIG. 1 is a perspective view illustrating a bobbin according to a first embodiment of the present disclosure;

FIG. 2 is a perspective view illustrating a core, to which the bobbin according to the first embodiment of the present disclosure may be coupled;

FIG. 3 is a perspective view of the core illustrated in FIG. 2, viewed from another direction;

FIG. 4 is a perspective view illustrating a first bobbin member of the bobbin according to the first embodiment of the present disclosure;

FIG. 5 is a perspective view illustrating a state, in which the bobbin according to the first embodiment of the present disclosure is coupled to the core;

FIG. 6 is a perspective view illustrating a bobbin according to a second embodiment of the present disclosure;

FIG. 7 is a perspective view illustrating a core, to which the bobbin according to the second embodiment of the present disclosure may be coupled;

FIG. 8 is a perspective view of the core illustrated in FIG. 7, viewed from another direction;

FIG. 9 is a perspective view illustrating a first bobbin member of the bobbin according to the second embodiment of the present disclosure;

FIG. 10 is a perspective view illustrating a state, in which the bobbin according to the second embodiment of the present disclosure is coupled to the core;

FIG. 11 is a perspective view illustrating a core-bobbin assembly for a stator including the bobbin according to the first embodiment of the present disclosure;

FIG. 12 is a view illustrating a state of the assembly illustrated in FIG. 11, viewed from a bottom; and

FIG. 13 is a perspective view illustrating a core-bobbin assembly for a stator including the bobbin according to the second embodiment of the present disclosure.

### DETAILED DESCRIPTION

Hereinafter, some embodiments of the present disclosure will be described in detail with reference to the exemplary drawings. In providing reference numerals to the constituent elements of the drawings, the same elements may have the same reference numerals even if they are displayed on different drawings. Further, in the following description of the present disclosure, a detailed description of known functions and configurations incorporated herein will be omitted when it may make the subject matter of the present disclosure rather unclear.

### First Embodiment

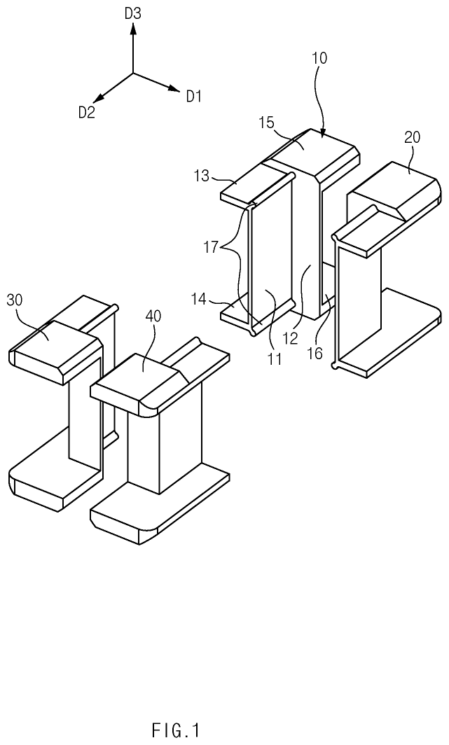

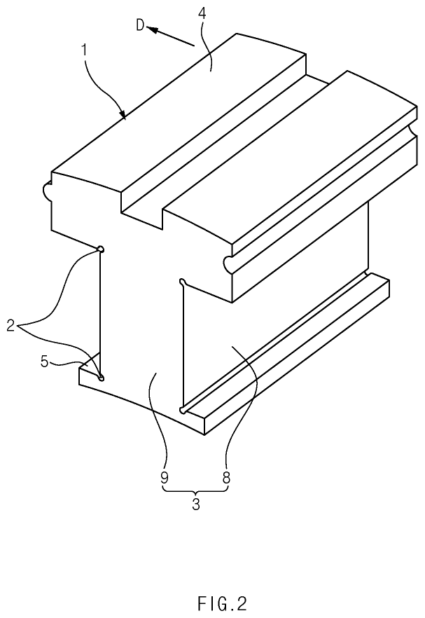

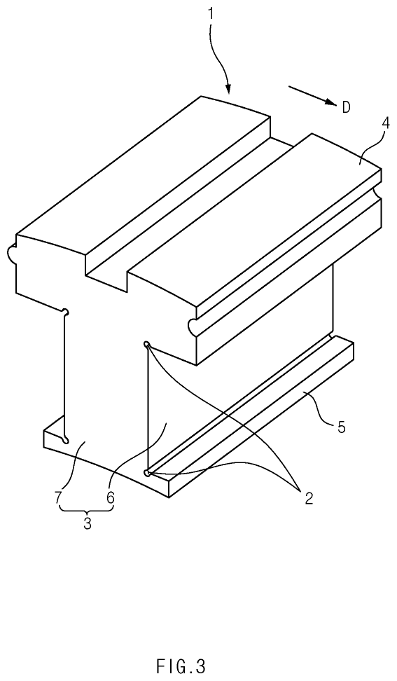

FIG. 1 is a perspective view illustrating a bobbin according to a first embodiment of the present disclosure. FIG. 2 is a perspective view illustrating a core, to which the bobbin according to the first embodiment of the present disclosure may be coupled. FIG. 3 is a perspective view of the core illustrated in FIG. 2, viewed from another direction.

The bobbin according to the first embodiment of the present disclosure, as illustrated in FIG. 1, may include a first bobbin member 10, a second bobbin member 20, a third bobbin member 30, and a fourth bobbin member 40.

The first bobbin member 10 may include a first part 11 and a second part 12. The first part 11 may extend while directions that cross a first direction D1 are taken as a widthwise direction and a lengthwise direction thereof. The second part 12 may be connected to the first part 11 and extend while directions that cross a direction, in which the first part 11 extends, are taken as a widthwise direction and a lengthwise direction thereof. For example, the second part 12 and the first part 11 may be perpendicular to each other.

The second bobbin member 20 may be spaced apart from the first bobbin member 10 along the first direction D1. The third bobbin member 30 may be spaced apart from the first bobbin member 10 along a second direction D2. The second direction D2 may be a direction that crosses the first direction D1. For example, the second direction D2 may be perpendicular to the first direction D1. The fourth bobbin member 40 may be spaced apart from the second bobbin member 20 along the second direction D2, and may be spaced apart from the third bobbin member 30 along the first direction D1.

A spacing distance between the first bobbin member 10 and the second bobbin member 20 may correspond to a spacing distance between the third bobbin member 30 and the fourth bobbin member 40. Furthermore, a spacing distance between the first bobbin member 10 and the third bobbin member 30 may correspond to a spacing distance between the second bobbin member 20 and the fourth bobbin member 40. For example, the spacing distance between the first bobbin member 10 and the second bobbin member 20 may be the same as the spacing distance between the third bobbin member 30 and the fourth bobbin member 40, and the spacing distance between the first bobbin member 10 and the third bobbin member 30 may be the same as the spacing distance between the second bobbin member 20 and the fourth bobbin member 40.

Meanwhile, according to the present disclosure, the first to fourth bobbin members 10, 20, 30, and 40 may have shapes and sizes that may be compatible. Then, the aspect that the shapes and the sizes are compatible may mean that the first to fourth bobbin members 10, 20, 30, and 40 have an identical property such that any one of the first to fourth bobbin members 10, 20, 30, and 40 may be replaced by another one. For example, the second bobbin member 20 may be mirror-symmetrical to the first bobbin member 10. Furthermore, the third bobbin member 30 may be mirror-symmetrical to the first bobbin member 10. Furthermore, the fourth bobbin member 40 may be mirror-symmetrical to the second bobbin member 20 and the third bobbin member 30.

According to the present disclosure, because the bobbin includes the first to fourth bobbin members 10, 20, 30, and 40 that may be compatible, the bobbin may be coupled to the core regardless of the size of the core. Accordingly, because the bobbin may be used regardless of the specification of the core, workability may be improved.

Hereinafter, a detailed shape of the first bobbin member 10 will be described.

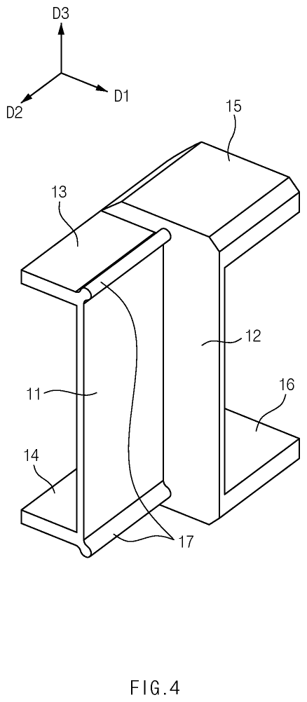

FIG. 4 is a perspective view illustrating the first bobbin member of the bobbin according to the first embodiment of the present disclosure.

Meanwhile, according to the present disclosure, the first to fourth bobbin members 10, 20, 30, and 40 may have the identical property to be compatible. Accordingly, a following description of the structure and the shape of the first bobbin member 10 may be applied to the second to fourth bobbin members 20, 30, and 40 in the same way.

As illustrated in FIG. 4, the first bobbin member 10 may include a third part 13 and a fourth part 14. The third part 13 and the fourth part 14 may be configurations that extend from opposite distal ends of the first part 11 in one direction. In more detail, the third part 13 may be a part that protrudes from a distal end of the first part 11 in a third direction D3, in a direction that is opposite to the first direction D1. Then, the third direction D3 may be one direction that is perpendicular to the first direction D1 and the second direction D2.

Meanwhile, the fourth part 14 may be a part that protrudes from a distal end of the first part 11 in a direction that is opposite to the third direction D3, in a direction that is opposite to the first direction D1. For example, a shape, in which the first part 11, the third part 13, and the fourth part 14 of the first bobbin member 10 are connected to each other, may be a staple shape as a whole.

The first bobbin member 10 may include a fifth part 15 and a sixth part 16. The fifth part 15 and the sixth part 16 may be configurations that extend from opposite distal ends of the second part 12 in one direction. In more detail, the fifth part 15 may be a part that protrudes from a distal end of the second part 12 in the third direction D3, in a direction that is opposite to the second direction D2. Meanwhile, the sixth part 16 may be a part that protrudes from a distal end of the second part 12 in the direction that is opposite to the third direction D3, in a direction that is opposite to the second direction D2. For example, a shape, in which the second part 12, the fifth part 15, and the sixth part 16 of the first bobbin member 10 are connected to each other, may be a staple shape as a whole.

Meanwhile, according to the present disclosure, a length, by which the second part 12 may extend along the third direction D3, is larger than a length, by which the first part 11 extends along the third direction D3, and the first part 11 may be disposed within the length, by which the second part 12 extends along the third direction D3. For example, the second part 12 and the first part 11 may be formed to have a specific step with respect to the third direction D3 and a direction that is opposite thereto. Accordingly, the third part 13 and the fifth part 15 may be formed to have a step with respect to the third direction D3. Furthermore, the fourth part 14 and the sixth part 16 may be formed to have a step with respect to a direction that is opposite to the third direction D3. Due to the stepped shape of the first bobbin member 10, as will be described below, the steps function as a kind of stoppers when the first part 11 of the first bobbin member 10 is coupled to the core 1 (see FIGS. 1, 2, and 3).

The bobbin according to the first embodiment of the present disclosure may include a boss 17. The boss 17 is provided on a surface of a configuration formed by coupling the first part 11, the third part 13, and the fourth part 14, and may have a protruding shape. In more detail, the boss 17 may be provided in an area, in which the first part 11 and the third part 13 meet each other, or an area, in which the first part 11 and the fourth part 14 meet each other. Alternatively, the boss 17 may be provided on a surface of the first part 11, the third part 13, or the fourth part 14. FIG. 4 illustrates, as an example, a state, in which the boss 17 is formed in the area, in which the first part 11 and the third part 13 meet each other, and the area, in which the first part 11 and the fourth part 14 meet each other.

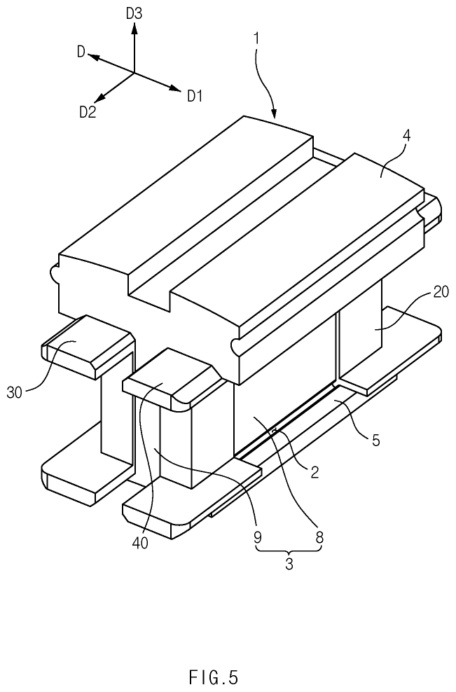

Meanwhile, as illustrated in FIGS. 2 and 3, a core groove 2 having a shape corresponding to the boss provided in the bobbin may be formed in the core 1. FIG. 5 is a perspective view illustrating a state, in which the bobbin according to the first embodiment of the present disclosure is coupled to the core. As illustrated in FIGS. 1 to 5, according to the first embodiment of the present disclosure, the bosses 17 provided in the first to fourth bobbin members 10, 20, 30, and 40 may be inserted into the core grooves 2 provided in the core 1, and thus the bobbin may be coupled to the core 1.

### Second Embodiment

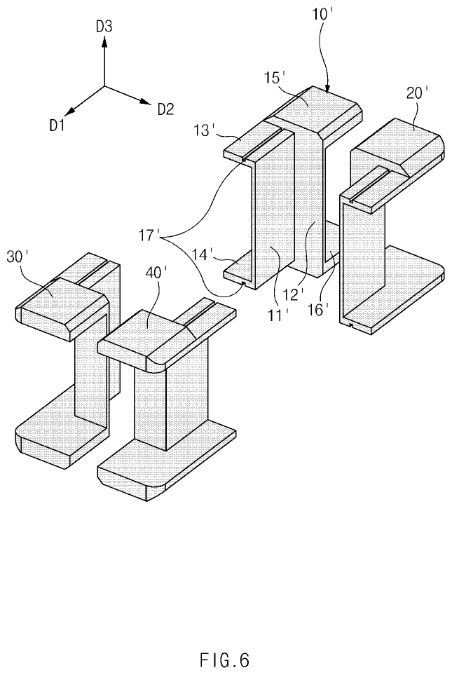

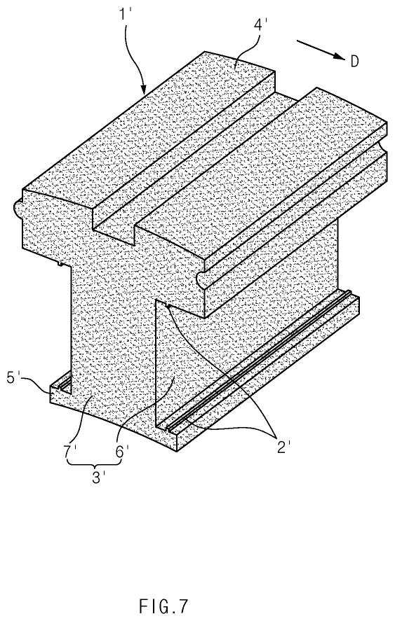

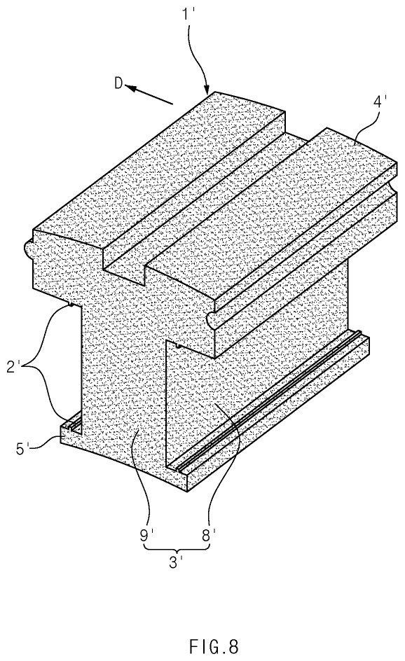

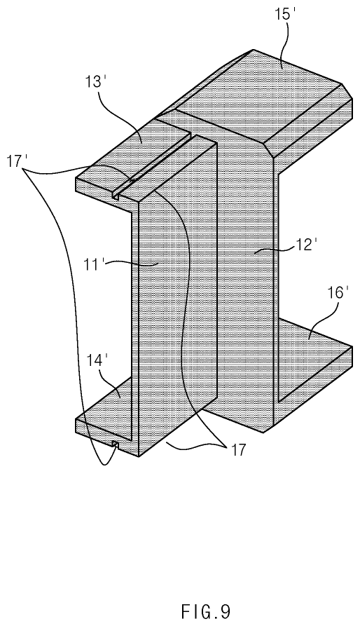

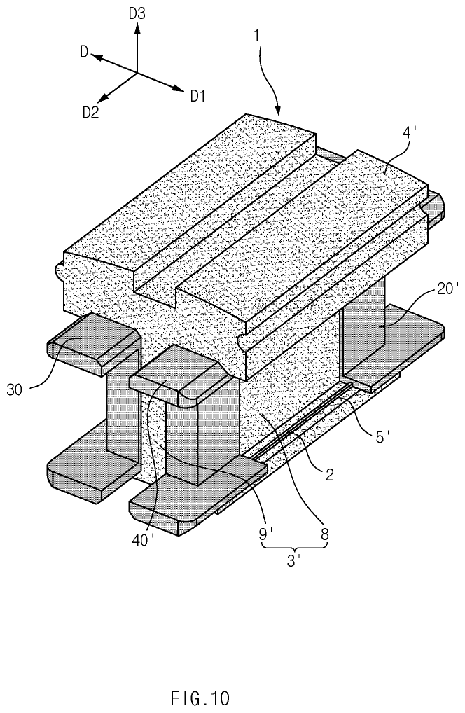

FIG. 6 is a perspective view illustrating a bobbin according to a second embodiment of the present disclosure. FIG. 7 is a perspective view illustrating a core, to which the bobbin according to the second embodiment of the present disclosure may be coupled. FIG. 8 is a perspective view of the core illustrated in FIG. 7, viewed from another direction. FIG. 9 is a perspective view illustrating a first bobbin member of the bobbin according to the second embodiment of the present disclosure. FIG. 10 is a perspective view illustrating a state, in which the bobbin according to the second embodiment of the present disclosure is coupled to the core.

Hereinafter, the second embodiment of the present disclosure will be described in detail with reference to FIGS. 6 to 10. Similarly to the bobbin according to the first embodiment, the bobbin according to the second embodiment also may include first to fourth bobbin members 10′, 20′, 30′, and 40′. However, the bobbin according to the second embodiment is different from the bobbin according to the first embodiment in that the first to fourth bobbin members 10′, 20′, 30′, and 40′ have grooves 17′ having a recessed shape instead of the bosses 17 (see FIG. 1) having the protruding shape. The same or corresponding reference numerals are given to configurations that are the same as or correspond to those of the bobbin according to the first embodiment, and a detailed description thereof will be omitted. Hereinafter, the bobbin according to the second embodiment will be described mainly with regard to differences from the bobbin according to the first embodiment.

As illustrated in FIGS. 6 and 9, a first bobbin member 10′ according to the second embodiment of the present disclosure may include a groove 17′ that is provided on a surface of a configuration formed by coupling a first part 11′, a third part 13′, and a fourth part 14′ and has a recessed shape. In more detail, the groove 17′ may be provided on a surface of the first part 11′, the third part 13′, or the fourth part 14′. FIGS. 6 and 9 illustrate a state, in which the grooves 17′ are provided on surfaces of the third part 13′ and the fourth part 14′. However, unlike this, the groove 17′ may be provided in an area, in which the first part 11′ and the third part 13′ meet each other, or an area, in which the first part 11′ and the fourth part 14′ meet each other. Furthermore, as illustrated in FIGS. 7 and 8, core bosses 2′ having a shape corresponding to the grooves 17′ may be formed in the core 1′. Accordingly, as illustrated in FIGS. 6 to 10, according to the second embodiment of the present disclosure, the core bosses 2′ may be inserted into the grooves 17′ provided in the first to fourth bobbin members 10′, 20′, 30′, and 40′, and thus the bobbin may be coupled to the core 1′.

### Core-Bobbin Assembly for Stator Including Bobbin of First Embodiment

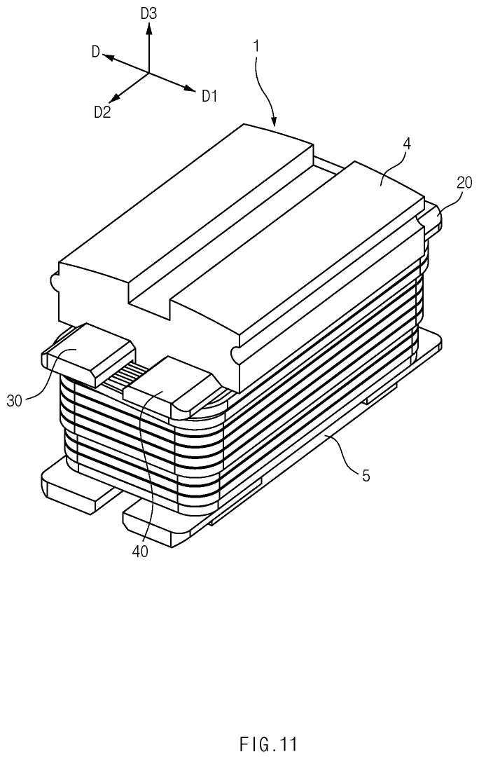

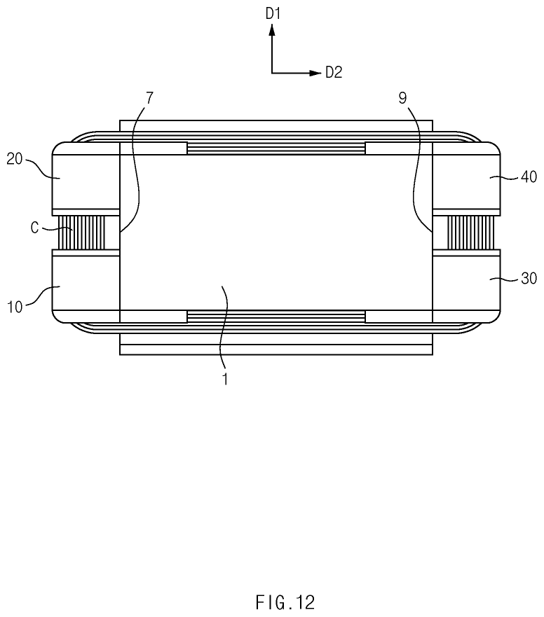

FIG. 11 is a perspective view illustrating a core-bobbin assembly for a stator including the bobbin according to the first embodiment of the present disclosure. FIG. 12 is a view illustrating a state of the assembly illustrated in FIG. 11, viewed from a bottom. Hereinafter, the core-bobbin assembly for a stator including the bobbin of the first embodiment of the present disclosure will be described with reference to FIGS. 11, 12, and 1 to 5. The same or corresponding reference numerals are given to configurations that are the same as or correspond to those of the bobbin according to the first embodiment, and a detailed description thereof will be omitted.

As illustrated in FIG. 11, the core-bobbin assembly for a stator including the bobbin according to the first embodiment may include the core 1, the first to fourth bobbin members 10, 20, 30, and 40, and a coil “C”. Then, as illustrated in FIGS. 2 and 3, the core 1 may include a yoke 3, a first flange 4, and a second flange 5. The first flange 4 may be coupled to an upper surface of the yoke 3, and may protrude in a reference direction “D” and a direction that is opposite thereto. The second flange 5 may be coupled to a lower surface of the yoke 3, and may protrude in the reference direction “D” and a direction that is opposite thereto.

Meanwhile, the yoke 3 may include a plurality of surfaces. In more detail, the yoke 3 may include an upper surface, a lower surface, and a plurality of side surfaces with reference to FIGS. 2 and 3.

Then, the first bobbin member 10 may be provided to contact a portion of the first surface 6 and a portion of the second surface 7 of the yoke 3. The first surface 6 may be, among the side surfaces of the yoke 3, a surface that is located in the reference direction “D”. Then, when the core 1 is viewed from a top, the side surfaces disposed in a clockwise sequence with respect to the first surface 6 may be sequentially named second to fourth surfaces 7, 8, and 9.

The second bobbin member 20 may be provided to contact a portion of the second surface 7 and a portion of the third surface 8 of the yoke 3, and may be spaced apart from the first bobbin member 10. The third bobbin member 30 may be provided to contact a portion of the first surface 6 and a portion of the fourth surface 9 of the yoke 3, and may be spaced apart from the first bobbin member 10. The fourth bobbin member 40 may be provided to contact a portion of the third surface 8 and a portion of the fourth surface 9 of the yoke 3, and may be spaced apart from the second bobbin member 20. The first to fourth bobbin members 10, 20, 30, and 40, as described above, may have shapes and sizes that may be compatible.

The coil “C” may be wound on outer surfaces of the first to fourth bobbin members 10, 20, 30, and 40. The aspect that the coil “C” is wound on the outer surfaces may mean that the coil “C” is wound on the outer surfaces of the adjacent bobbin members along a clockwise direction or counterclockwise direction, while any one of the first to fourth bobbin members 10, 20, 30, and 40 is taken as a starting point.

As described above, according to the first embodiment of the present disclosure, each of the first to fourth bobbin members 10, 20, 30, and 40 may include a boss 17 provided at a portion of a surface that contact the core 1 and having a shape that protrudes outwards. The core 1 may include core grooves 2 formed to correspond to the bosses 17 of the first to fourth bobbin members 10, 20, 30, and 40 and provided such that the bosses 17 may be inserted thereinto. For example, the core grooves 2 may be formed at a connection portion of the first flange 4 and the yoke 3 or a connection portion of the second flange 5 and the yoke 3. FIGS. 2 and 3 illustrate that the core grooves 2 are provided at the connection portion of the first flange 4 and the yoke 3 and the connection portion of the second flange 5 and the yoke 3.

As illustrated in FIG. 12, the first and second bobbin members 10 and 20 may protrude outwards from the second surface 7 such that the wound coil “C” is spaced apart from the second surface 7 by a specific distance. Furthermore, the third and fourth bobbin members 30 and 40 also may protrude outwards from the fourth surface 9 such that the wound coil “C” is spaced apart from the fourth surface 9 by a specific distance.

According to the core-bobbin assembly for a stator including the bobbin of the first embodiment of the present disclosure, because the first and second bobbin members 10 and 20 may protrude outwards from the second surface 7 such that the wound coil “C” is spaced apart from the second surface 7 by the specific distance and the third and fourth bobbin members 30 and 40 may protrude outwards from the fourth surface 9 such that the wound coil is spaced apart from the fourth surface 9 by the specific distance, cooling fluid may be introduced between the coil “C” and the second surface 7 or between the coil “C” and the fourth surface 9, and thus cooling efficiency may be improved. In more detail, when the core-bobbin assembly for a stator is viewed from a bottom, as illustrated in FIG. 12, an empty space may be formed between the coil “C” and the core 1, and the cooling fluid may be introduced through the empty space.

### Core-Bobbin Assembly for Stator Including Bobbin of Second Embodiment

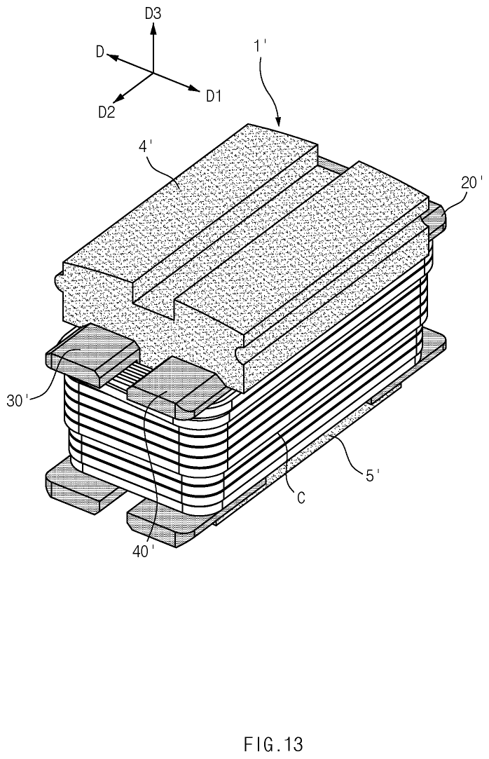

FIG. 13 is a perspective view illustrating a core-bobbin assembly for a stator including the bobbin according to the second embodiment of the present disclosure. Hereinafter, the core-bobbin assembly for a stator including the bobbin of the second embodiment of the present disclosure will be described with reference to FIGS. 13, and 6 to 10. The core-bobbin assembly for a stator including the bobbin according to the second embodiment is different from the core-bobbin assembly for a stator including the bobbin according to the first embodiment in that the first bobbin member 10′ includes grooves 17′ (see FIG. 6) instead of the bosses 17 (see FIG. 1). The same or corresponding reference numerals are given to configurations that are the same as or correspond to those of the core-bobbin assembly for a stator including the bobbin according to the first embodiment, and a detailed description thereof will be omitted.

Each of the first to fourth bobbin members 10′, 20′, 30′, and 40′ may include the groove 17′ provided on a surface thereof and having a recessed shape. The core 1′ may include core bosses 2′ formed to correspond to the grooves 17′ of the first to fourth bobbin members 10′, 20′, 30′, and 40′ and provided such that the core bosses 2′ may be inserted into the grooves 17′. For example, as illustrated in FIGS. 7 and 8, the core bosses 2′ may protrude from a first flange 4′ in a direction that is opposite to the third direction D3. Alternatively, the core bosses 2′ may protrude from the second flange 5′ in the third direction D3.

According to the present disclosure, because the bobbin may be coupled to the core regardless of the size of the core through the compatible bobbin members, workability may be increased in a process of manufacturing the motor or the stator.

Furthermore, according to the present disclosure, because the spacing space is formed between the coil and the core-bobbin assembly for a stator, the cooling fluid may pass through the spacing space so that the stator including the coil may be smoothly cooled.

The above description is a simple exemplification of the technical spirits of the present disclosure, and the present disclosure may be variously corrected and modified by those skilled in the art to which the present disclosure pertains without departing from the essential features of the present disclosure. Accordingly, the embodiments disclosed in the present disclosure is not provided to limit the technical spirits of the present disclosure but provided to describe the present disclosure, and the scope of the technical spirits of the present disclosure is not limited by the embodiments. Accordingly, the technical scope of the present disclosure should be construed by the attached claims, and all the technical spirits within the equivalent ranges fall within the scope of the present disclosure.

What is claimed is:

1. A bobbin, comprising:
a first bobbin member including a first part extending in a direction that crosses a first direction, and a second part extending in a direction that crosses the direction in which the first part extends;
a second bobbin member spaced apart from the first bobbin member along the first direction;
a third bobbin member spaced apart from the first bobbin member in a second direction that crosses the first direction; and
a fourth bobbin member spaced apart from the second bobbin member along the second direction, and spaced apart from the third bobbin member along the first direction,
wherein the first, second, third, and fourth bobbin members have shapes and sizes that are compatible.

2. The bobbin of claim 1, wherein the second bobbin member is mirror-symmetrical to the first bobbin member.

3. The bobbin of claim 2, wherein the third bobbin member is mirror-symmetrical to the first bobbin member.

4. The bobbin of claim 3, wherein the fourth bobbin member is mirror-symmetrical to the second bobbin member and the third bobbin member.

5. The bobbin of claim 1, wherein the first bobbin member includes:
a third part protruding, in a direction opposite to the first direction, from a distal end of the first part in a third direction that is perpendicular to the first direction and the second direction; and
a fourth part protruding, in the direction opposite to the first direction, from a distal end of the first part in a direction that is opposite to the third direction.

6. The bobbin of claim 5, wherein the first bobbin member includes:
a boss having a protruding shape and disposed on a surface of a structure formed by the first part, the third part, and the fourth part being coupled together.

7. The bobbin of claim 6, wherein the boss is disposed in an area in which the first part and the third part meet each other, or an area in which the first part and the fourth part meet each other.

8. The bobbin of claim 6, wherein the boss is disposed on a surface of the first part or the third part.

9. The bobbin of claim 5, wherein the first bobbin member includes:
a groove having a recessed shape and disposed on a surface of a structure formed by coupling the first part, the third part, and the fourth part.

10. The bobbin of claim 9, wherein the groove is disposed on a surface of the first part, the third part, or the fourth part.

11. The bobbin of claim 9, wherein the groove is disposed in an area in which the first part and the third part meet each other, or an area in which the first part and the fourth part meet each other.

12. The bobbin of claim 1, wherein a spacing distance between the first bobbin member and the second bobbin member corresponds to a spacing distance between the third bobbin member and the fourth bobbin member, and
wherein a spacing distance between the first bobbin member and the third bobbin member corresponds to a spacing distance between the second bobbin member and the fourth bobbin member.

13. The bobbin of claim 1, wherein the first bobbin member includes:
a fifth part protruding, in a direction opposite to the second direction, from a distal end of the second part in a third direction that is perpendicular to the first direction and the second direction; and
a sixth part protruding, in the direction opposite to the second direction, from a distal end of the second part in a direction opposite to the third direction.

14. The bobbin of claim 1, wherein a length by which the second part extends along a third direction that is perpendicular to the first direction and the second direction is larger than a length by which the first part extends along the third direction, and
wherein the first part is disposed in the length by which the second part extends along the third direction.

15. A core-bobbin assembly for a stator, comprising:
a core including:
a yoke, the yoke having a first surface located on a side of a side surface of the yoke, in a reference direction, and second to fourth surfaces disposed in a clockwise sequence when viewed from a top of the yoke;
a first flange coupled to an upper surface of the yoke and protruding in the reference direction and a direction that is opposite to the reference direction; and
a second flange coupled to a lower surface of the yoke and protruding in the reference direction and the direction that is opposite to the reference direction;
a first bobbin member configured to contact a portion of the first surface and a portion of the second surface;
a second bobbin member configured to contact another portion of the second surface and a portion of the third surface, and spaced apart from the first bobbin member;
a third bobbin member configured to contact another portion of the first surface and a portion of the fourth surface, and spaced apart from the first bobbin member;
a fourth bobbin member configured to contact another portion of the third surface and another portion of the fourth surface, and spaced apart from the second bobbin member; and
a coil wound on outer surfaces of the first to fourth bobbin members,
wherein the first to fourth bobbin members have shapes and sizes that are compatible.

16. The core-bobbin assembly of claim 15, wherein each of the first to fourth bobbin members includes a boss disposed on a surface thereof, and having a shape that protrudes outward,
wherein the core includes a core groove disposed on a surface thereof and having a shape that is recessed inward, and
wherein the boss included in each of the first to fourth bobbin members is inserted into the core groove such that the first to fourth bobbin members and the core are coupled to each other.

17. The core-bobbin assembly of claim 15, wherein each of the first to fourth bobbin members includes a groove having a recessed shape and disposed at a portion of a surface that contacts the core,
wherein the core includes a core boss disposed on a surface of the core and having a shape that protrudes outward, and
wherein the core boss is inserted into the groove included in each of the first to fourth bobbin members, such that the first to fourth bobbin members and the core are coupled to each other.

18. The core-bobbin assembly of claim 15, wherein the first and second bobbin members protrude outward from the second surface such that the coil is spaced apart from the second surface by a specific distance, and
wherein the third and fourth bobbin members protrude outward from the fourth surface such that the coil is spaced apart from the fourth surface by a specific distance.
